(19) United States
(12) Patent Application Publication
(10) Pub. No.: US 2026/0043275 A1
(43) Pub. Date: Feb. 12, 2026

(54) Locking Vault Cover System

(71) Applicant: Seaton Automation LLC, Fort Worth, TX (US)

(72) Inventor: Ernest J. Seaton, Fort Worth, TX (US)

(73) Assignee: Seaton Automation LLC, Fort Worth, TX (US)

(21) Appl. No.: 19/293,565

(22) Filed: Aug. 7, 2025

Related U.S. Application Data
(60) Provisional application No. 63/680,578, filed on Aug. 7, 2024.

(51) Int. Cl. E05G 1/026; E05G 1/04

(52) U.S. Cl. CPC E05B 65/006; E05B 67/36

(57) ABSTRACT

A vault cover assembly includes a locking cover, a locking bracket, and a lock, to form an interior separator plate between utility endpoints in a vault and the vault lid. The locking bracket is installed inside the vault, supported by mounting assemblies, and includes a crosspiece and a locking structure to which the lock locks. The locking cover is installed on, and locked to, the locking bracket and includes a cover plate with a formed hole through which the locking structure passes for locking. A locking vault system includes a vault with an interior separator plate installed.

### REFERENCE TO RELATED APPLICATIONS

This application claims priority to provisional patent application 63/680,578.

### FIELD OF THE INVENTION

The invention relates to in-ground vaults for utility endpoints, such ends of, or access to, cables and connections. Such vaults include handwells, pullboxes, handholes, and may be made of concrete or polycarbonate or similar materials. The vaults are set in the ground, and may be set into a concrete pad, to accommodate those utility endpoints to cables, lines, and other utilities that run underground. The vaults include an exterior lid, which may be screwed on or otherwise latched to the vault. This is commonly done by setting the lid on an internal ledge in the vault, so that the lid is flush or near to flush with the ground/grade level. When closed, the vault protects the endpoints from damage or theft (e.g. of copper from telecommunication or power lines). When open, the vault permits access to the endpoints. The lid may close the vault.

### BACKGROUND OF THE INVENTION

The present invention solves a problem in that vault lids may not lock or may not be capable of being securely locked to the vault. The present invention solves a problem in that locked exterior vault lids may expose the lock / locking mechanism to the elements or to mechanical damage, or easy removal to remove the lid.

### BRIEF STATEMENT OF THE INVENTION

In an embodiment, a vault cover assembly includes a locking cover, a locking bracket, and a lock. When installed, the vault cover assembly is an interior separator plate between the endpoints and the lid and the exterior of the vault. These may all be made of metals, such as steel, or other strong materials such as polycarbonate.

The locking bracket is transverse and includes a transverse crosspiece, and mount ends opposite of one another on said crosspiece, and a mounting assembly mounted by bolt or other method to each mount end. The mounting assembly may be formed as a connector (e.g. bolt or pin) for fixing said mounting assembly to a utility vault. Mounting assemblies may be mounted at an inset height below the ledge of the vault to provide space for the lock and cover plate below the exterior lid and to permit the vault cover assembly to be an interior separator. The crosspiece of the locking bracket includes locking structure on the top of the locking bracket, which may be vertically-extending or vertical. The locking structure may include a shaft hole for accepting the locking shaft of a lock. The locking structure may be formed as a substantially flat tab, the shaft hole being defined between the flat sides, or may be formed as a loop, the shaft hole being defined by the loop, or may be formed as a round stud, the shaft hole being defined across the round face of the cylinder.

The locking cover has a cover plate formed to substantially cover the vault interior therebelow from access and to separate the utility endpoints from exterior access. The cover plate has a tab hole defined therethrough for the locking structure, including any shaft hole therein, to extend therethrough upwardly past said cover plate,. The locking cover also may include a lock shield extending vertically-upward from the cover plate, where the lock shield may form a partial enclosure around the tab hole. The lock shield may be a partial cylinder formed with one end fixed to the cover plate, the other open to the top, and the missing part of the rounded form of the cylinder forming partial enclosure and a key access open to the side. The cover plate can include lock mounting holes defined therethrough for bolting or otherwise fixing a lock to the top of the cover plate.

The lock may include a locking shaft that is movable, e.g. transversely or arcuately, and has both an unlocked position and a locked position within said lock. The lock may be locked and unlocked using a key or other known methods. The lock may include a body, where the body has a bottom and a tab recess defined in the body, where the tab recess has an opening exposed to the bottom. When the locking shaft is in the locked position, the locking shaft is positioned across the tab recess. When the locking shaft is in the unlocked position, the locking shaft may be withdrawn from the tab recess to a shaft recess.

When the locking bracket is installed in the vault, and the locking cover is installed on the locking bracket, and the lock is locked to the locking structure of the locking bracket, thus locking the locking cover to the locking bracket, the vault cover assembly is locked and prevents access to the vault's interior. When this is accomplished, the vault cover assembly is interior to the utility vault and is below the exterior lid. The vault cover assembly thus forms an interior separator plate between the exterior lid and the utility endpoints, and protects those endpoints from access even if the exterior lid is removed.

The lock is locked to the locking structure. The locking shaft in the locked position is positioned through said shaft hole and within the lock, and in said unlocked position is not extending through said shaft hole. At least part of the locking structure is received in the tab recess, including at least the shaft hole. In the locked position, the locking shaft is interlocked within the lock, within the shaft recess and at the shaft end to the shaft capture, and also to the locking structure.

To lock the vault cover assembly the following steps may be followed: fix one or more mounting assemblies to a vault, such as with a pin or bolt, position the vertically-extending locking structure facing upward on the top of the transverse locking bracket, mount each mount end of the transverse crosspiece of the locking bracket to one of the mounting assemblies, place a locking cover having a cover plate over the locking bracket, where the cover plate has a tab hole defined therethrough, and fit the locking structure to extend through the tab hole and past the cover plate. The locking structure may be formed as a substantially flat tab, where the shaft hole is defined between the flat sides and is for accepting the locking shaft of a lock.

The locking cover may be locked to the locking bracket, by locking the lock to the locking structure. Locking may include inserting the locking structure into the tab recess defined in the body of the lock, including the shaft hole of the locking structure. Locking may include moving a locking shaft, e.g. transversely, in the lock from an unlocked position to a locked position within said lock, and by moving the locking shaft through the shaft hole in the locking structure. The locking shaft may move transversely from fully or substantially within the shaft recess and fully not or substantially not within the tab recess, in the unlocked position to fully or substantially across the tab recess, through the shaft hole of the locking structure, and at least partially within the shaft capture, in the locked position. For unlocking, the steps are reversed, to move the locking shaft out of the shaft hole, and to permit the locking cover to be removed by permitting it to move upwardly over the locking structure, and the locking structure to move through the tab hole.

### BRIEF DESCRIPTION OF THE FIGURES

FIGS. 1A-1B are, respectively, a top, and front side views of vault cover assembly fixed to a vault.

FIG. 1C is a partial cross-section along line A-A from FIG. 1A.

FIG. 2 is an oblique top, right, rear view of a part of a vault cover assembly.

FIG. 3 is an oblique top, right, front view of a part of a vault cover assembly.

FIG. 4A is a top front view of a vault prior to installation of a vault cover assembly.

FIG. 4B is a top perspective view of part of a vault cover assembly installed in a vault.

FIG. 4C is a top front view of a vault with a vault cover assembly installed.

FIG. 5A is a top view of a lock of a vault cover assembly.

FIGS. 5B-5C are bottom views of a lock of a vault cover assembly in, respectively, an unlocked position and a locked position.

FIGS. 6A-6B are top views of, respectively, a part of a vault cover assembly installed in a vault, and a vault with a vault cover assembly installed.

### DETAILED DESCRIPTION OF THE INVENTION

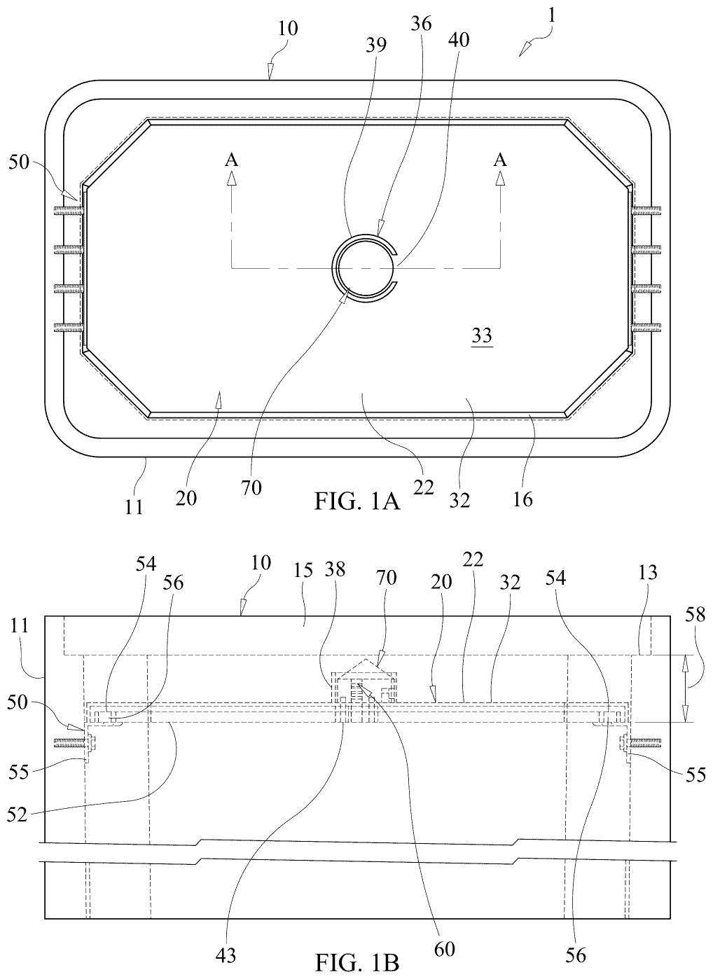

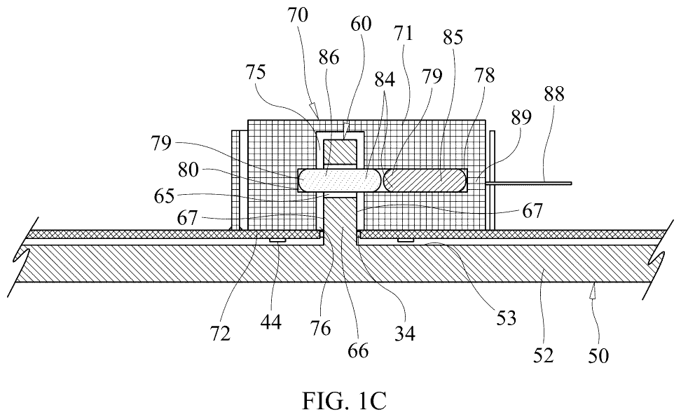

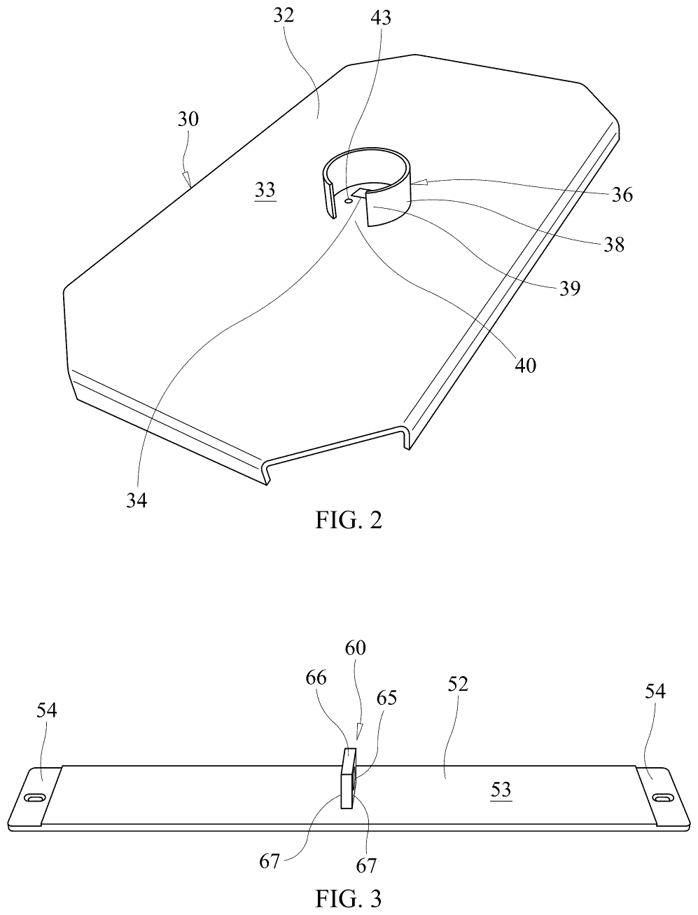

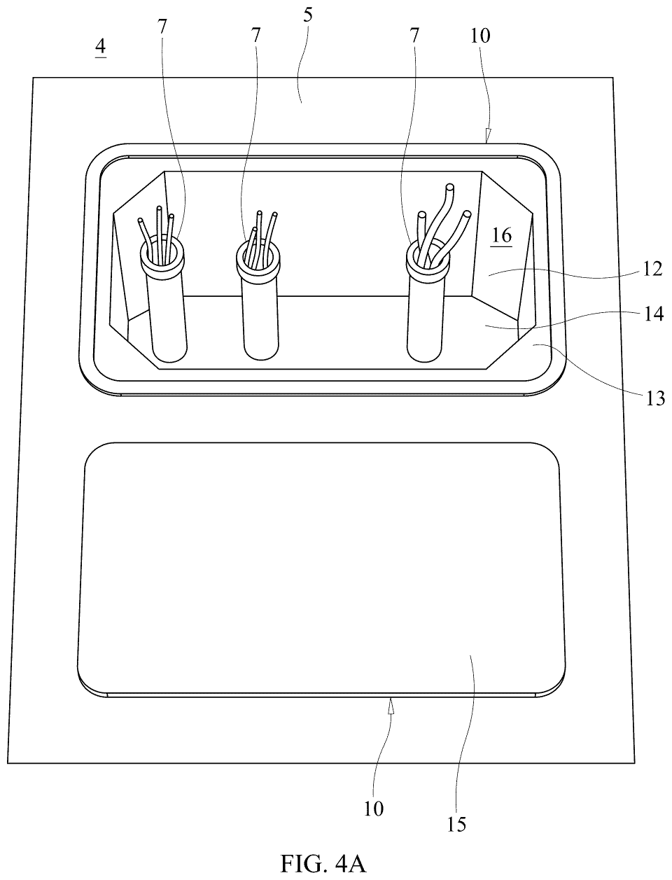

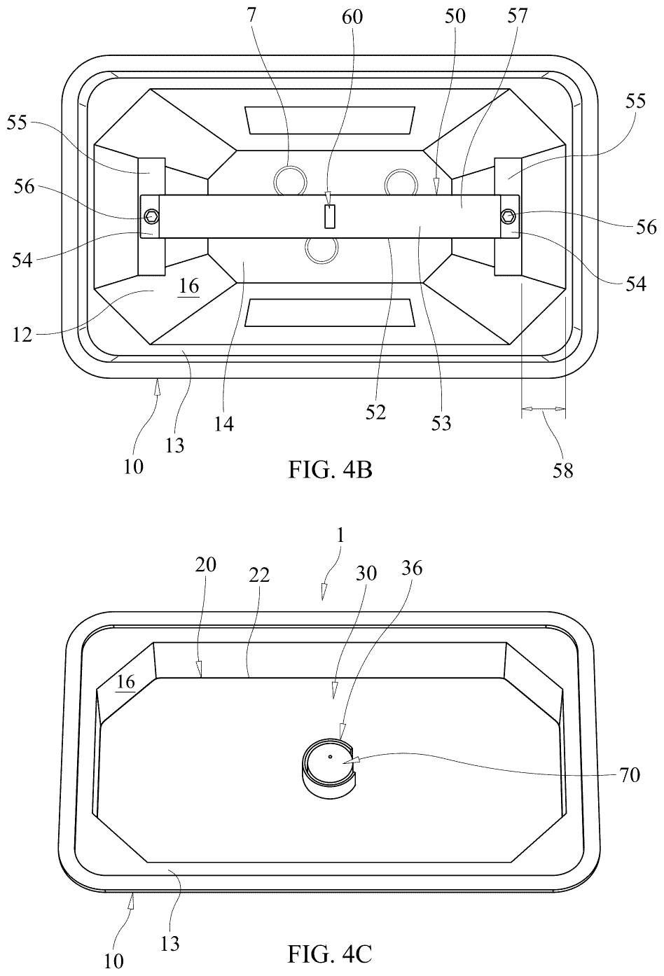

Referring to FIGS. 1A-5C, in an embodiment, locking vault system 1 includes vault 10 and vault cover assembly 20.

Vault 10 includes interior 12, permitting utility or other access to endpoints 7, surrounded by inner walls 16 and floor 14 beneath lid 15. Above inner walls 16 and around an upper periphery thereof is ledge 13 on which lid 15 may be seated to close vault 10 and from which lid 15 may be lifted to open vault and expose vault cover assembly 20. Vault 10 has exterior 11, which includes the space above lid 15. Vault 10 is installed in pad 5 at or near to flush with ground 4. Installed, vault cover assembly 20 forms interior separating plate 22 between endpoints 7 and lid 15 and exterior 11, and between floor 14 and lid 15.

Referring to FIGS. 1A-5C, in an embodiment, vault cover assembly 20 includes locking cover 30, locking bracket 50, and lock 70.

Locking bracket 50 is installed across interior 11 of vault 10 and includes crosspiece 52 and mounting assemblies 55. Crosspiece 52 includes top 53, locking structure 60 on top 53, and mount ends 54 opposite of one another along top 53. Mounting assemblies 55 are fixed to opposing inner walls 16 of vault 10, at inset height 58 below ledge 13, using connectors 56. Each mount end 54 of crosspiece 52 is mounted to one of mounting assemblies 55 by bolt or other method to fix and support locking bracket 50 to inner walls 16 of vault 10. Locking structure 60 is tab 66 vertically-extending from locking bracket 50 and from top 53 of crosspiece 52. Tab 66 includes opposing sides 67 (e.g. oriented transversely) and shaft hole 65 defined between sides 67 for accepting locking shaft 84 of lock 70.

Locking cover 30 is installed to locking bracket 50 and includes cover plate 32, lock shield 36, and lock mounting holes 43. Locking cover 30 includes top 33, and tab hole 34 defined therethrough to permit locking structure 60, including shaft hole 65, to extend therethrough upwardly past top 33. Lock shield 36 extend vertically-upward from top 33 of cover plate 32 in the form of a partial cylinder around tab hole 34 to create partial enclosure 39 and key access 40 to one side. Cover plate includes lock mounting holes 43 defined therethrough for bolting or otherwise fixing lock 70 to top 33 of cover plate 32 using connectors 44.

Lock 70 includes body 71, locking shaft 84, key 88, and key mechanism 89.

Body 71 has bottom 72, opening 76 on bottom 72, tab recess 75 defined in body 71 extending upward from opening 76. Body 71 also includes shaft recess 78 defined therein and connected to tab recess 75. Locking shaft 84 includes shaft end 79 and is movable between unlocked position 85 and locked position 86 within lock 71. In locked position 86, locking shaft 84 is positioned across tab recess 75 and shaft end 79 extends into shaft capture 80; in unlocked position 85, locking shaft 84 is withdrawn from tab recess 75 to shaft recess 78. Key 88 is used in key mechanism 89 to lock and unlock lock 70 and move it between unlocked position 85 and locked position 86.

In an embodiment, for locking vault system 1, vault cover assembly 20 is within vault 10, below lid 15 and spaced apart therefrom. Locking bracket 50 is installed to interior walls 16 of vault 10 using mounting assemblies 55 at inset height 58 below ledge 13, locking cover 30 is installed on locking bracket 50, and lock 70 is locked to locking structure 60 of locking bracket 50. Locking cover 30 rests on and is supported by locking bracket 50, and particularly by crosspiece 52 and mounting assemblies 55. Thus, locking bracket 50 is fixed to vault 10, locking cover 30 is locked to locking bracket 50 using lock 70, and locking vault system 1 prevents access to interior 12 of vault 10. Vault cover assembly 20 is interior to vault 10 and below lid 15 to form interior separator plate 22 between lid 15 and endpoints 7.

When lock 70 is locked to locking structure 60, locking shaft 84 (in locked position 86) is positioned through shaft hole 65 and tab recess 75, with shaft end 79 in shaft capture 80. Here, at least part of locking structure 60 is received in tab recess 75, including at least shaft hole 65. Thus, in locked position 86, locking shaft 84 is interlocked within lock 70, within shaft recess 78 and within shaft capture 80 at shaft end 79, as well as to the locking structure 60. In unlocked position 85, locking shaft 84 does not extend through shaft hole 65 and is in shaft recess 78.

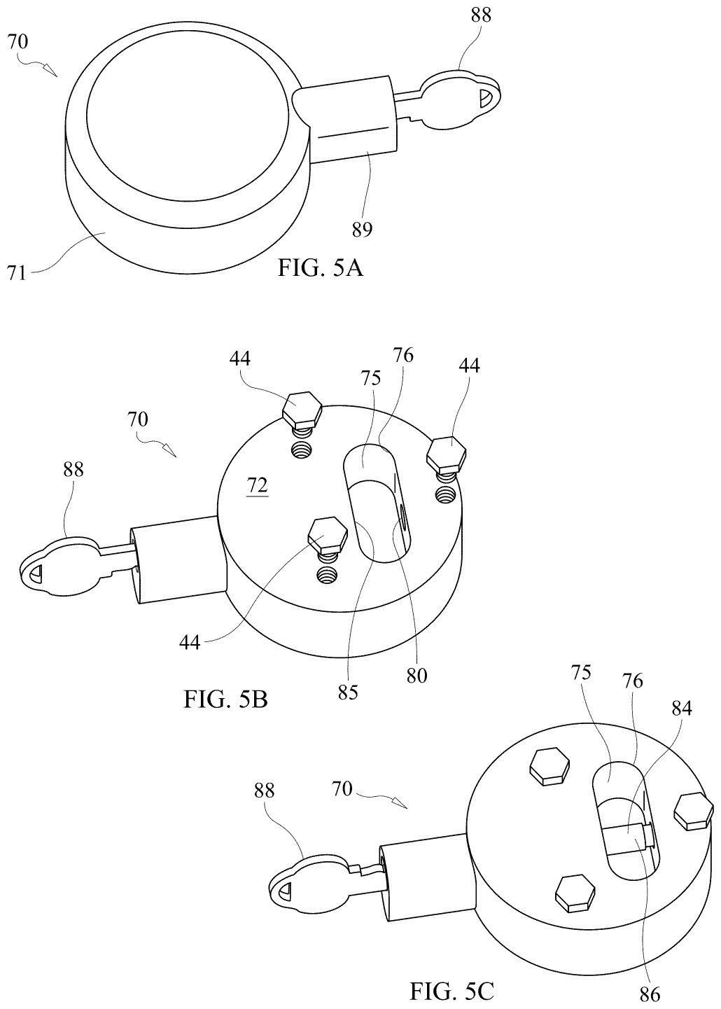

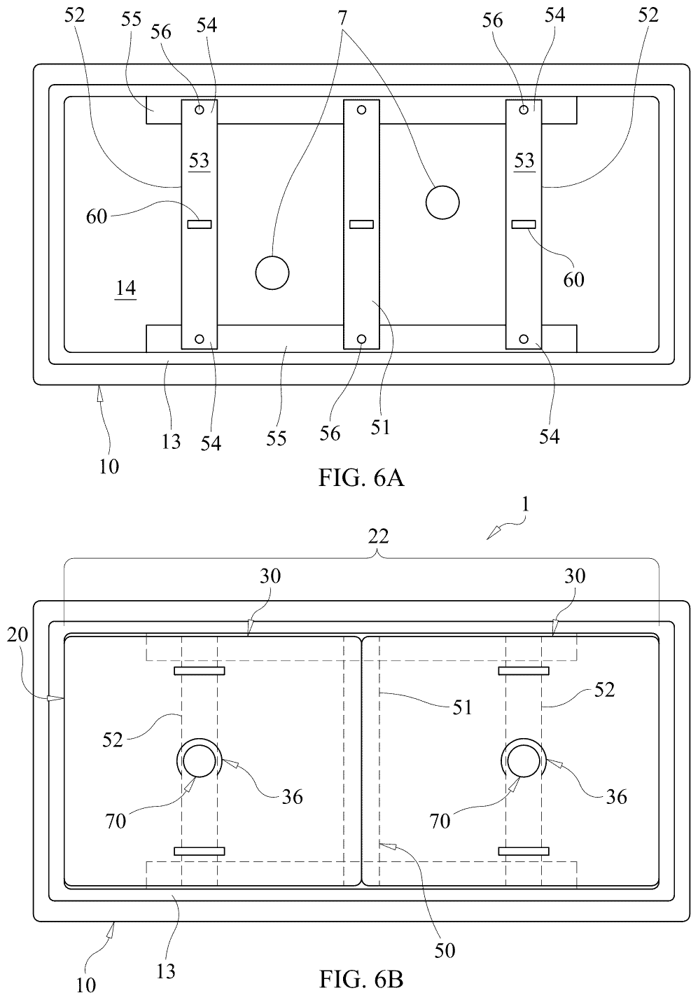

Referring to FIGS. 5A-5C & 6A-6B in an embodiment, locking vault system 1 includes vault 10 and vault cover assembly 20. Vault cover assembly 20 includes two locking covers 30, locking bracket 50, and two locks 70. Description of elements above is adopted those in this embodiment.

Similar to the other embodiment, locking bracket 50 is installed across interior 11 of vault 10 but includes two crosspieces 52, support rail 51 between crosspieces 42, and mounting assemblies 55. Crosspieces 52 are as described, and each includes locking structure 60. Locks 70 are as described. Locking covers are as described. Mounting assemblies 55 are fixed to opposing inner walls 16 of vault 10, at inset height 58 below ledge 13. Each mount end 54 of crosspieces 52 are mounted to one of mounting assemblies 55 by bolt or other method to fix and support locking bracket 50 to inner walls 16 of vault 10. Likewise support rail 51 is mounted to mounting assemblies 55 between crosspieces 52. Mounting assemblies 55 may be a single unit for mounting mount ends 54 of both crosspieces 52 and support rail 51, or discrete sections for each of crosspieces 52 and support rail 51. One of locking covers 30 is locked as described to a locking structure 60 of locking bracket 50, and the other locking covers 30 is locked as described to the other locking structure 60. Each locking cover 30 rests on and is supported by support rail 51, in addition to locking bracket 50, particularly by one of the crosspieces 52. Thus, two locking covers 30 are placed side-by-side to form interior separating plate 22 between endpoints 7 and lid 15 and exterior 11.

The following steps may be followed to lock vault cover assembly 20 of locking vault system 1: fix one or more of mounting assemblies 55 to vault 10 using connector 56 at inset height 58, position locking structure 60 facing upward on locking bracket 50, mount each mount end 54 of crosspiece 52 to one of mounting assemblies 55, place locking cover 30 having cover plate 32 over locking bracket 50, where cover plate 32 has tab hole 34 defined therethrough, and fit locking structure 60 to extend through tab hole 34 and past cover plate 32. Lock locking cover 30 to locking bracket 50 via locking structure 60 includes inserting locking structure 60, including the shaft hole 65, into tab recess 75 in body 71 of lock 70, and through tab hole 34. Operate key 88 in key mechanism 89 to move locking shaft 84 from unlocked position 85 to locked position 86 and through shaft hole 65 in locking structure 60.

For unlocking, the steps are reversed, to move locking shaft 84 out of shaft hole 65, and to permit locking cover 30 to be removed by permitting it to move upwardly over locking structure 50, and locking structure 60 to move through tab hole 34.

Where there are multiple locking covers, the process is repeated.

1. A vault cover assembly comprising:
a locking cover; and
a locking bracket having at least one mount end;
the locking bracket and comprising
a mounting assembly on said at least one mount end; and
a vertically-extending locking structure on a top of the locking bracket; and
the locking cover having a cover plate having a tab hole defined therethrough for the locking structure to extend therethrough.

2. The vault cover assembly of claim 1,
the locking structure comprising a shaft hole for accepting the locking shaft of a lock.

3. The vault cover assembly of claim 1,
the locking bracket further comprising a crosspiece, and two of said mount ends opposite of one another on said crosspiece; and
one each of said mounting assemblies on each mount end.

4. The vault cover assembly of claim 1,
two of said locking covers; and
said locking bracket comprising two of said locking structures.

5. The vault cover assembly of claim 1,
the locking cover further comprising
a lock shield extending vertically-upward from said cover plate;
said lock shield forming a partial enclosure around said tab hole.

6. The vault cover assembly of claim 1,
said locking bracket mounted to an interior wall of a vault; and
said mounting assembly mounted at an inset height below the ledge of the vault.

7. The vault cover assembly of claim 1,
the locking structure comprising
a tab having opposing sides; and
a shaft hole being defined between the opposing sides.

8. The vault cover assembly of claim 1, further comprising a lock;
the lock comprising a locking shaft;
said locking shaft
being transversely movable; and
having an unlocked position and a locked position within said lock.

9. The vault cover assembly of claim 8,
said locking structure extending through and upwardly past said cover plate;
the locking structure comprising a shaft hole;
said locking shaft in said locked position positioned through said shaft hole; and
said locking shaft in said unlocked position not extending through said shaft hole.

10. The vault cover assembly of claim 8,
the lock comprising a body, the body having a bottom and a tab recess defined therein;
the tab recess having an opening exposed to the bottom;
and the locking shaft in said locked position positioned across said tab recess.

11. The vault cover assembly of claim 8,
the locking structure comprising a substantially flat tab;
the lock comprising a bottom and a tab recess defined therein and exposed to the bottom;
at least a portion of the tab received in said tab recess; and
the locking shaft in said locked position positioned through said shaft hole.

12. The vault cover assembly of claim 1, further comprising a lock;
the lock comprising a body, the body having a bottom and a tab recess defined therein, and a locking shaft;
said locking shaft having an unlocked position and a locked position within said lock.

13. The vault cover assembly of claim 12,
the locking structure comprising a shaft hole;
at least the shaft hole of the locking structure received in said tab recess; and
said locking shaft in said locked position positioned through said shaft hole.

14. A method of locking a vault cover assembly, comprising:
positioning upward-facing a vertically-extending locking structure on a top of a locking bracket;
at least one mount end of the locking bracket having at least one mounting assembly; and
placing a locking cover having a cover plate over said locking bracket;
said cover plate having a tab hole defined therethrough; and
fitting the locking structure to extend through said tab hole and past said cover plate.

15. The method of claim 14, further comprising:
connecting the at least one mounting assembly to a vault at an inset height below a ledge of the vault.

16. The method of claim 14,
the locking bracket further comprising a crosspiece; and
the crosspiece comprising two of said mount ends;
the connecting step further comprising connecting two of said mounting assemblies to the vault; and
mounting each of said mount ends to one each of said mounting assemblies.

17. The method of claim 14,
the locking structure comprising a tab having opposing sides; and
the shaft hole being defined between the opposing sides.

18. The method of claim 14, further comprising locking the locking cover to the locking bracket;
the locking step comprising transversely moving a locking shaft from an unlocked position to a locked position within said lock.

19. The method of claim 18,
the locking step further comprising moving the locking shaft through a shaft hole in said locking structure.

20. The method of claim 19, further comprising an unlocking step;
the unlocking step comprising moving the locking shaft out of said shaft hole.

21. The method of claim 14, further comprising locking the locking cover to the locking bracket;
the locking step comprising
inserting the locking structure into a tab recess defined in a body of the lock; and
transversely moving a locking shaft in the lock into the tab recess and locking it to said locking structure.

22. A locking vault system comprising:
a vault; and
an interior separating plate;
the vault comprising
a floor;
a lid; and
the interior separating plate fixed between the floor and the lid.

23. The locking vault system of claim 22,
the interior separating plate comprising
a locking bracket; and
a locking cover;
the locking cover removeable from the locking bracket;
the locking bracket comprising
a crosspiece; and
a locking structure on said crosspiece; and
the locking structure extending through said locking cover.

24. The locking vault system of claim 23,
the locking structure on a top of the crosspiece;
the locking cover comprising a cover plate; and
the cover plate having a tab hole defined therethrough for the locking structure to extend therethrough.
